(19) United States
(12) Patent Application Publication
(10) Pub. No.: US 2012/0251322 A1
(43) Pub. Date: Oct. 4, 2012

(54) Rotating fluid conduit utilized such a propeller or turbine, characterized by a rotating annulus, formed by a rotating inner hub and a rotating outer shell

(76) Inventor: Phillip Jackson McGee, Cleveland, MS (US)

(21) Appl. No.: 13/200,137

(22) Filed: Sep. 19, 2011

Related U.S. Application Data
(60) Provisional application No. 61/465,954, filed on Mar. 28, 2011.

(51) Int. Cl. F01D 5/22; B64C 11/00; B63H 1/16

(52) U.S. Cl. 416/189

(57) ABSTRACT

A rotating fluid conduit, utilized such as a propeller or turbine, is disclosed that is characterized by a rotating annulus formed by a rotating inner hub and a rotating outer shell. Rotating internal vanes are arranged within the annulus and are affixed to the inner hub and the outer shell. The annulus area varies from the inlet to the outlet and the angle of the vanes, within the annulus, also varies to control the radial velocity and axial velocity of the fluid stream and thereby provide a corresponding change in the axially directed and radially directed energy of a fluid. This rotating fluid conduit is analytically calculated, to an exact solution, to deliver predictable performance at design and off design conditions.

This application claims priority from applicant's U.S. Provisional Patent Application Ser. No. 61/465,954, filed on Mar. 28, 2011.

A rotating fluid conduit utilized such as a propeller or turbine, characterized by a rotating annulus, formed by a rotating inner hub and a rotating outer shell. Rotating internal vanes are arranged within the annulus and are affixed to the inner hub and the outer shell. The annulus area varies from the inlet to the outlet and the angle of the vanes within the annulus varies to control the tangential velocity and axial velocity of the fluid stream.

### CROSS-REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention is in the field of endeavors related to dynamics of fluid motion more particularly to rotating fluid conduits such as turbine rotors and propellers designed using computer simulation.

There is a focus on the design of ships and ferries that can achieve 70 knot plus speeds. But current propeller technology cannot produce a propeller to supply the required thrust at these speeds.

Conventional propellers operate in “sucking mode” relying on negative pressure at the forward portion of the propeller. The flow of fluid “sucked” into the forward face, of the open type conventional propeller, is then mostly ejected radially from the propeller. The faster the forward speed of the vessel the less negative “sucking” force is generated at the forward face of the propeller. The revolutions per minute (RPM) of the propeller must be increased in order to increase the flow, to compensate for the reduction in negative pressure at the forward face of the propeller. But, the higher the RPM of the propeller, the more fluid is ejected radially until eventually cavitation occurs at the blade faces and the propeller “crashes”.

The prior art has disclosed means to reduce the radial velocity of the fluid but reducing the radial velocity reduces flow and/or reduces the effective area of the effective forward face of the propeller and reduces performance or increases cavitation.

Jet pump propelled boats do not exhibit the same problems as propellers of the prior art because jet type propulsion relies on positive thrust generated by the fluid being ejected rearward at a greater velocity than the forward speed of the vessel. The fluid flow and the area of the outlet nozzle determine the speed of the fluid exiting at the outlet.

A diligent search revealed no prior references disclosing controlling the annulus area of a rotating propeller to effect an increased rearward velocity of the fluid. While varying the area of fluid exit is common to non-rotating nozzles, this class would not apply to the rotating annulus of a propeller or turbine.

The Propulsion Committee, Final Report and Recommendations to the 25th ITTC, 2008, available on the Internet; is hereby incorporated by reference.

For over 100 years, the prior art has never completely understood the dynamics of a propeller. Attempts at predicting the performance of a propeller have been attempted by the use of numerical methods because the prior art had deemed an exact analytical solution too complicated. But, numerical methods are an approximation at best and then only within a narrow range of values. Numerical methods have proved ineffective in the design predictability of conventional open propellers outside the known range of values. i.e., forward speed, shaft revolutions per minute (RPM).

Manatees, seals, porpoises, and whales are just a few of the water creatures that have been devastated by the exposed cantilevered blades of conventional marine propellers.

There exists, therefore, a need for a propeller that has improved performance, that can be analytically calculated, and is safer for marine life.

The working fluid in an axial flow turbine flow parallel to the axis of rotation. A conventional radial centrifugal turbine is a turbine in which the flow of the working fluid is radial to the shaft. While radial centrifugal turbines are efficient, the intricate casing configuration makes the cost of large conventional radial centrifugal turbines prohibitive. Since the outer housing of the prior art is stationary, viscous drag caused by the tangential velocity of the fluid relative to the non rotating outer housing robs power output and reduces efficiency.

Boyce, M. P., Gas Turbine Engineering Handbook Second Edition, Butterworth-Hienemann, 2003; is incorporated by reference.

Existing design turbine rotors involves collecting data from tests wherein: several blades are placed in a row, called a “cascade” and exposed to a fluid stream, in an attempt to simulate a compressor rotating fluid conduit. This method tests the current cascade but is inaccurate when attempts are made to extrapolate the test data to other turbine configurations.

There exists, therefore, a need for a power generating turbine that has predictable and improved performance, lower viscous drag, and that can provide reaction, impulse, and axially directed centrifugal extraction of energy.

### BRIEF SUMMARY OF THE INVENTION

The present invention, “rotating fluid conduit”, is unique and novel in that it is characterized by a rotating annulus formed by a rotating inner hub and a rotating outer shell with rotating internal vanes, arranged within the annulus and affixed to the inner hub and the outer shell. The annulus area varies from the inlet to the outlet and the angle of the vanes within the annulus also varies to effect a change in the tangential and axial velocity of the fluid stream and thereby provide a corresponding change in the axially directed and tangentially directed energy of a fluid.

When the rotating fluid conduit is embodied as a propeller, the diameter of the exit of the hub is larger than the diameter of the entry of the hub therefore the annular area located at the outlet is less than the annular area located at the inlet. This reduction in annular area from the inlet to the outlet causes the speed of the fluid, exiting the outlet to increase. Increasing the speed, of the fluid at the outlet, results in a positive axial thrusting force being exerted upon the propeller.

Contrary to the prior art, at design speed the present invention can have 100% positive thrust and 0% negative pressure at the forward face. Cavitation cannot exist in the absence of negative pressure.

The present invention has an inherent safety feature given that the outside diameter of the rotating vanes are not exposed. Therefore marine life is not exposed to “tangential slicing”. The rotating outer shell can also be axially extended forward of the “leading edge” of the vanes and/or behind the “trailing edge” to give added protection from accidental “reach in” of hands, fins, feet, flippers, and other biological appendages.

When the present invention is embodied as a power generating turbine, the rotating fluid conduit can provide extraction of fluid energy using the difference in centrifugal force from the fluid flow at the inlet to the fluid flow at the outlet. Reduction of the centrifugal radius at the outlet annulus from that of the centrifugal radius at the inlet annulus provides a change in centrifugal force from the inlet to the outlet that causes rotational energy to be transmitted to the rotating fluid conduit. Contrary to the prior art the outer shell rotates as part of the rotating fluid conduit so therefore there is no viscous drag caused by the tangential velocity of the fluid.

By varying the arrangement of the vanes at the inlet, the present invention can also concurrently provide impulse extraction of fluid energy from the fluid striking the forward face of the vanes. The present invention can also simultaneously provide extraction of fluid energy via reaction by varying the design of the annulus and the vanes so that tangential velocity of the fluid, at the outlet, will impart rotational energy to the rotating fluid conduit.

Since the radial velocity of the fluid flow does not exist in the present invention, the axial and tangential components of the fluid can be calculated to exact analytical solution rather than approximated by the numerical methods of the prior art. The resulting three dimensional (3D) design of the annulus areas and the angle of the vanes results in predictable improved performance and greater efficiency over that of the prior art. As examples: A marine or aircraft propeller can be designed to maximize the axial component of the fluid flow, at the outlet, for maximum thrust. A power generating turbine can alternatively be designed with the tangential velocity (reaction) and the annular radius (centrifugal) at the outlet of the working fluid adjusted to produced maximum rotational power output.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated alternate embodiments of the invention.

### BRIEF DESCRIPTION OF THE SEVERAL VIEWS OF THE DRAWING

For the embodiments depicted in FIGS. 1, 4, and 6, a computer program, pursuant to this invention, produced an exact analytical solution to the chosen performance values which were input into the computer program. Another computer program then generated three dimensional (3D) models based on these exact analytical solutions. FIGS. 1, 4, and 6 are perspective two dimensional (2D) views of the respective computer generated 3D models. FIGS. 2, 3, 5, 7, and 8 are also 2D views of the computer generated 3D models but with portions of the 3D models removed for clarity.

FIG. 1 is a perspective two dimensional (2D) view of a computer generated three dimensional (3D) model of a marine propeller in accordance with a first embodiment of the invention.

FIG. 2 is a perspective two dimensional (2D) view of the computer generated three dimensional (3D) model illustrated in FIG. 1 but with a portion of the rotating outer shell cut away to expose the internal vanes and hub.

FIG. 3 is a perspective two dimensional (2D) view of the computer generated three dimensional (3D) model illustrated in FIG. 1 but with the entire rotating outer shell removed to expose only one of the internal vanes and hub.

FIG. 4 is a perspective two dimensional (2D) view of a computer generated three dimensional (3D) model with a portion of the rotating outer shell cut away to expose the three internal vanes and hub.

FIG. 5 is a perspective two dimensional (2D) view of the computer generated three dimensional (3D) model illustrated in FIG. 4 but with the entire rotating outer shell removed to expose only one of the internal vanes and hub.

FIG. 6 is a perspective two dimensional (2D) view of a computer generated three dimensional (3D) model of a power generating turbine in accordance with a second embodiment of the invention.

FIG. 7 is a perspective two dimensional (2D) view of the computer generated three dimensional (3D) model illustrated in FIG. 6 but with a portion of the rotating outer shell cut away to expose the internal vanes and hub.

FIG. 8 is a perspective two dimensional (2D) view of the computer generated three dimensional (3D) model illustrated in FIG. 6 but with the entire rotating outer shell removed to expose only one of the internal vanes and hub.

### DETAILED DESCRIPTION OF THE INVENTION

Detailed descriptions of two possible embodiments of the invention, marine propeller and power generating turbine, are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A more complete understanding of the invention and many of the attendant advantages thereof will be readily appreciated as the same becomes better understood by reference to the following detailed description when considered in connection with the accompanying drawings wherein: analogous parts are identified by like reference numerals as follows:
100 Rotating fluid conduit embodied as either a propeller or power generating turbine
101 Inlet
101a Fluid flow into inlet
102 Outlet
102b Fluid flow from outlet
103 Hub
104 Attached rotating outer shell
105 Vane (typical)
106 Shaft and axis of rotation
107a-107b Cutaway section of cylindrical enclosure
199 Direction of rotation
108 Inlet diameter of rotating outer shell
109 Outlet diameter of rotating duct
110 Force
312 Hub inlet diameter
313 Hub outlet diameter
314 Leading edge of vane (typical)
315 Trailing edge of vane (typical)

Similar to propellers, pump impellers, compressors, fans, and power generating turbines the present invention can be made in various sizes and configurations including but not exclusively with any number of vanes, varying diameters of the rotating outer shell and varying diameters of the inner hub. It should be recognized that the present invention is not limited to the use in propellers and generating turbines having the specific designs which are herein described for purposes of example.

### Embodiment 1

### Marine Propeller

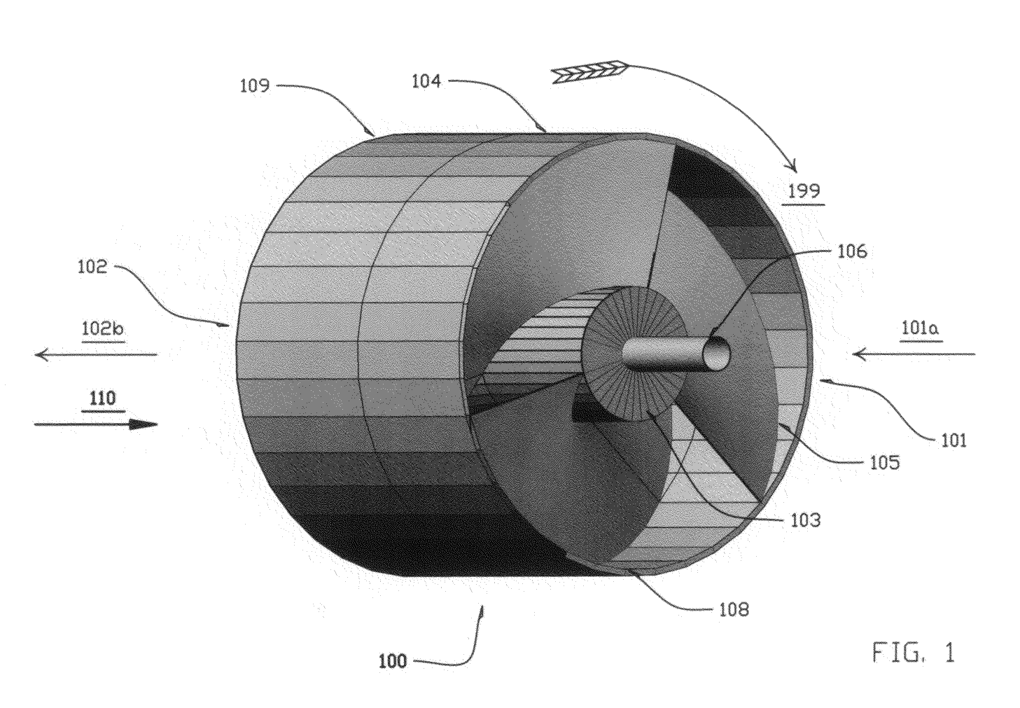

Referring jointly to FIGS. 1, 2, and 3 of the drawings, the embodiment of the present invention as a boat propeller has a cylindrical inner hub 103 and three vanes typical of 105 which extend radially from the hub 103 to the interior of the attached rotating outer shell 104.

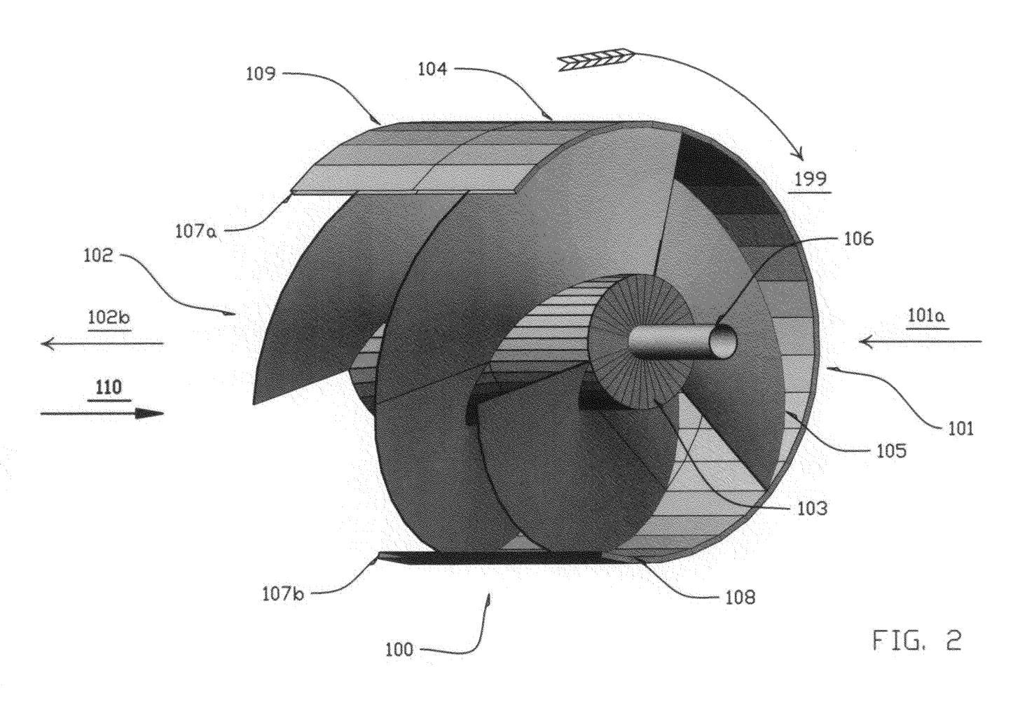

FIG. 2 depicts the propeller 100 of FIG. 1 but with a section 107a-107b of the rotating outer shell cut away to expose the internal vanes typical of 105 and the hub 103.

The rotating outer shell 104 is attached to the vanes 105 and rotates along with the hub 103 and the vanes typical of 105.

Hub 103 is depicted, in this example, with an axially directed shaft 106 for the purpose of transmitting rotational energy to the propeller 100. Alternatively, rotational energy to the propeller 100 could be transmitted via the rotating outer shell.

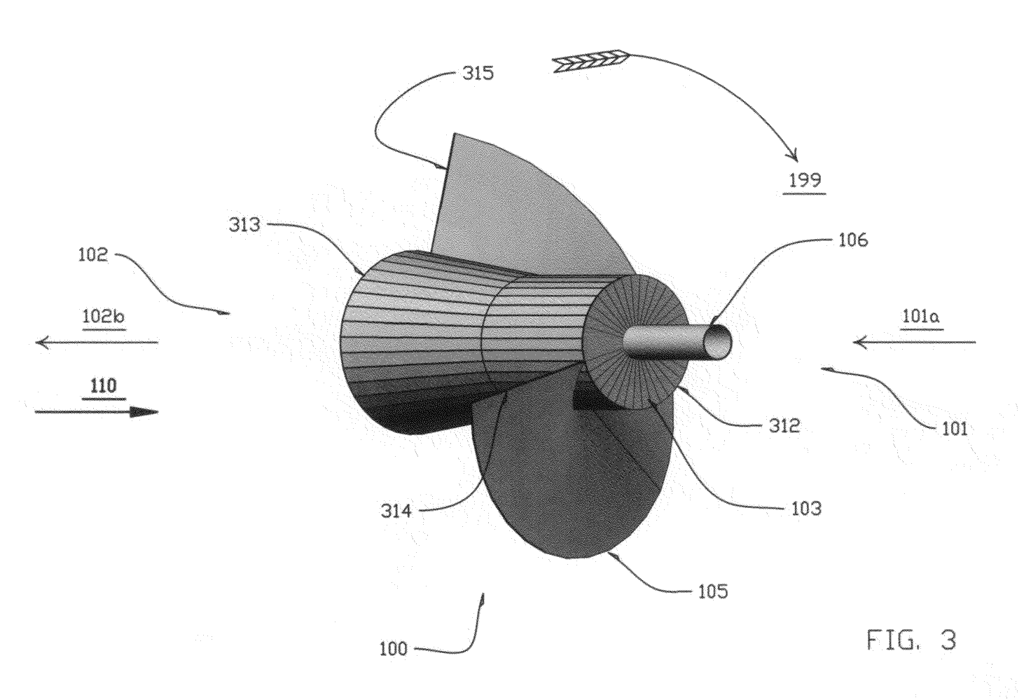

FIG. 3 depicts the entire rotating outer shell removed to expose only one of the internal vanes 105 and the hub 103. The propeller 100 of this particular example turns in a clockwise direction as indicated by arrow 199 in the drawing. Thus edge 314 is a leading edge with respect to the revolving motion 199 of the vane 105 and edge 315 is a trailing edge.

The vanes typical of 105 are pitched relative to the axis of rotation 199 of the propeller 100 to cause a flow of fluid 101a into the inlet 101 and a flow of fluid 102b from the outlet 102, when the propeller 100 is rotated.

As depicted in FIG. 2, the space between the outer inlet diameter 312 of the hub 103 and the inner inlet diameter 108 of the rotating outer shell 104 forms an annulus at the inlet 101 of the propeller 100.

As depicted in FIG. 2, the outer outlet diameter 313 of the hub 103 and the inner outlet diameter 109 of the rotating outer shell 104 forms an annulus at the outlet 102 of the propeller 100.

As depicted in FIGS. 1 and 2 the diameter 108 of the inlet 101 of the rotating outer shell 104 is equal to the diameter 109 of the outlet 102 of the rotating outer shell 104.

As depicted in FIG. 3 the diameter 313 of the outlet of the hub 103 is larger than the diameter 312 of the inlet of the hub 103. Therefore the annular area of the outlet 102 is less than the annular area of the inlet 101.

This reduction in annular area from inlet 101 to outlet 102 causes the speed of the fluid 102b, exiting the outlet 102, to increase. Increasing the speed of the fluid 102b at the outlet 102 results in an axial thrusting force 110 being exerted upon the propeller 100.

The design of the rotating outer shell, the hub, and the vanes are analytically calculated for the for the desired performance of the rotating fluid conduit.

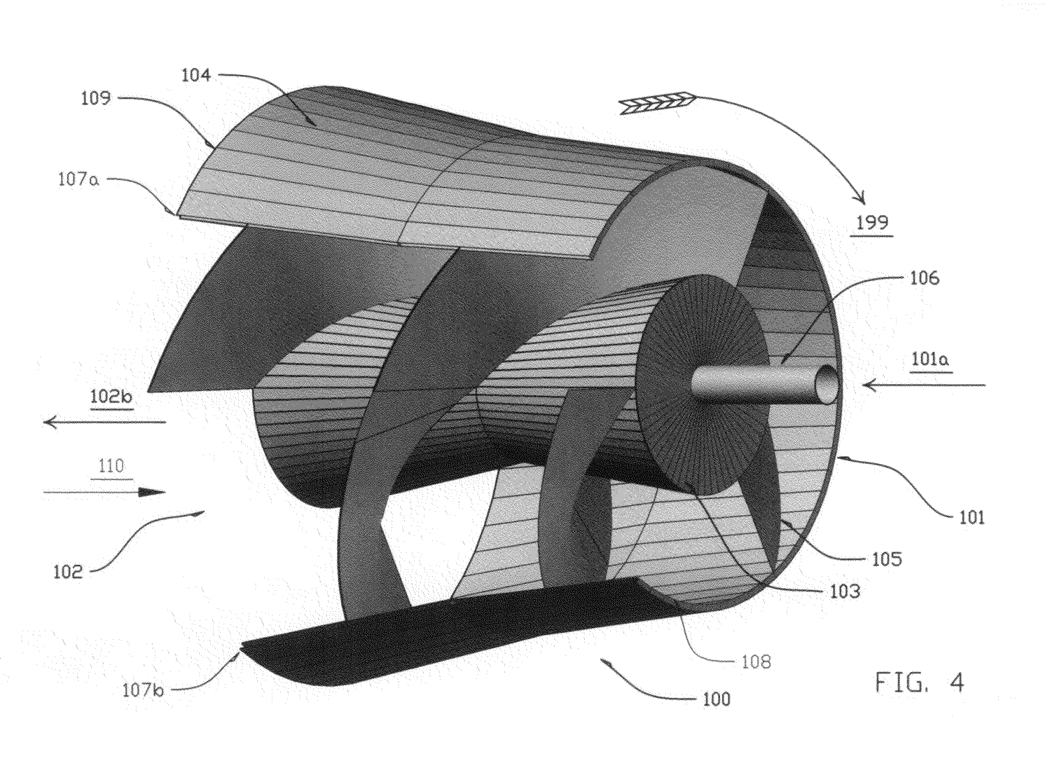

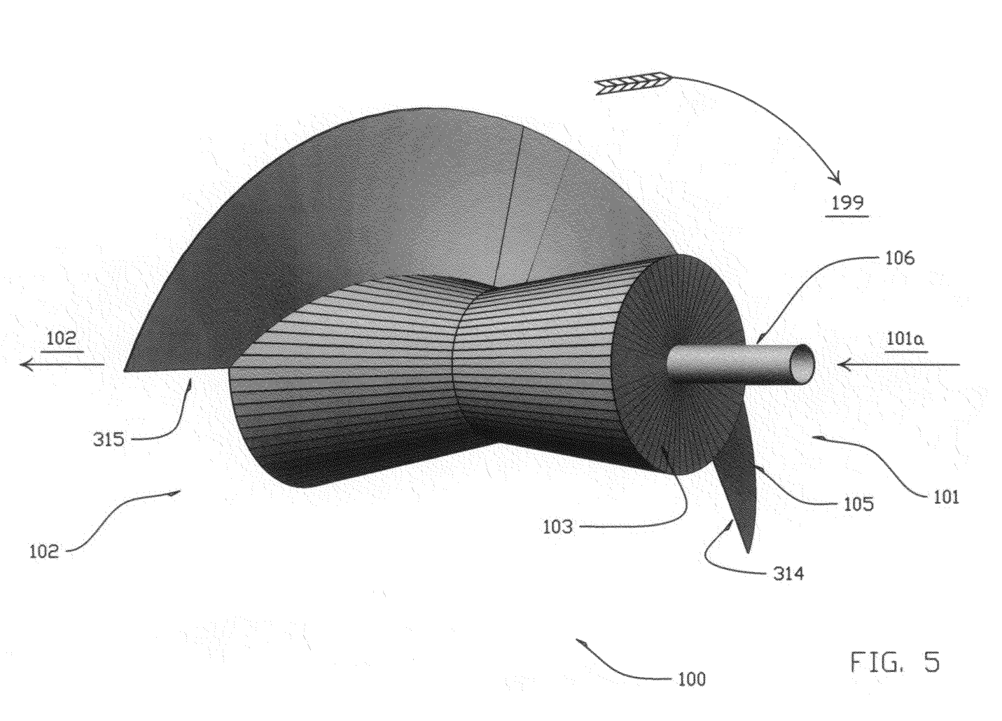

In the example depicted in FIGS. 1 and 2 the inlet diameter 108 and outlet diameter 109 of the rotating outer shell 104 are equal but depending upon the application, the inlet diameter 108 and outlet diameter 109 of the rotating outer shell 104 can be different as depicted in FIGS. 4 and 5.

### Embodiment 2

### Power Generating Turbine Incorporating Centrifugal Extraction

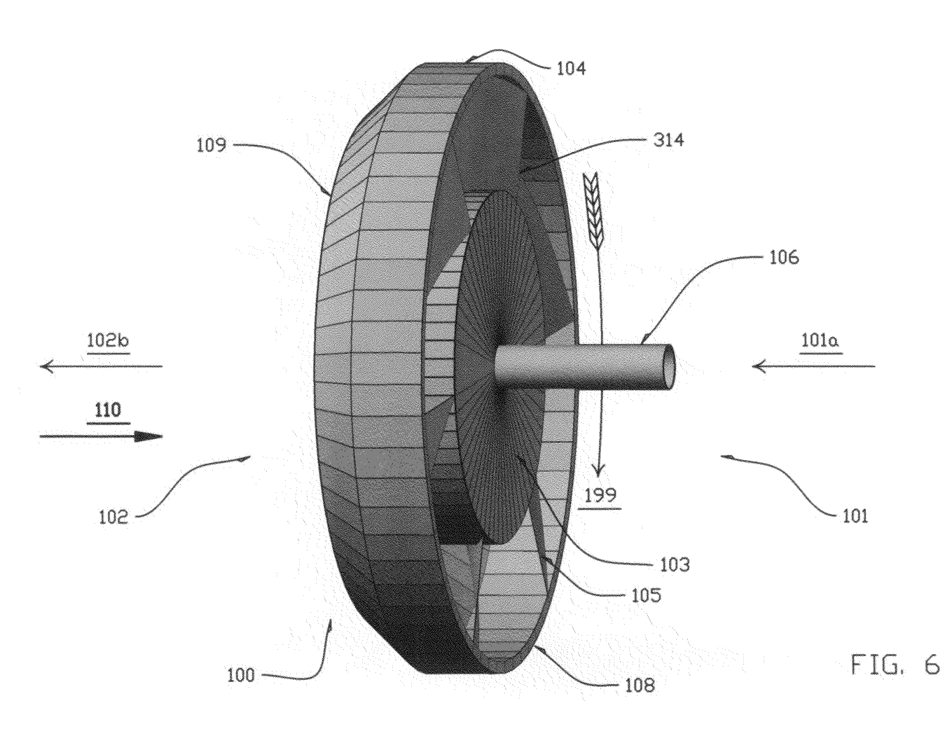

FIGS. 6, 7, and 8 depict another example of the invention as applied to a power generating turbine having six vanes typical of 105. In this example the power generating turbine 100 is designed to extract energy by reduction of the centrifugal force from inlet 101 to the outlet 102.

Referring jointly to FIGS. 6, 7, and 8 of the drawings, the embodiment of the present invention as a power generating turbine has a cylindrical hub 103 and six vanes typical of 105 which extend radially from the hub 103 to the interior of the attached rotating outer shell 104.

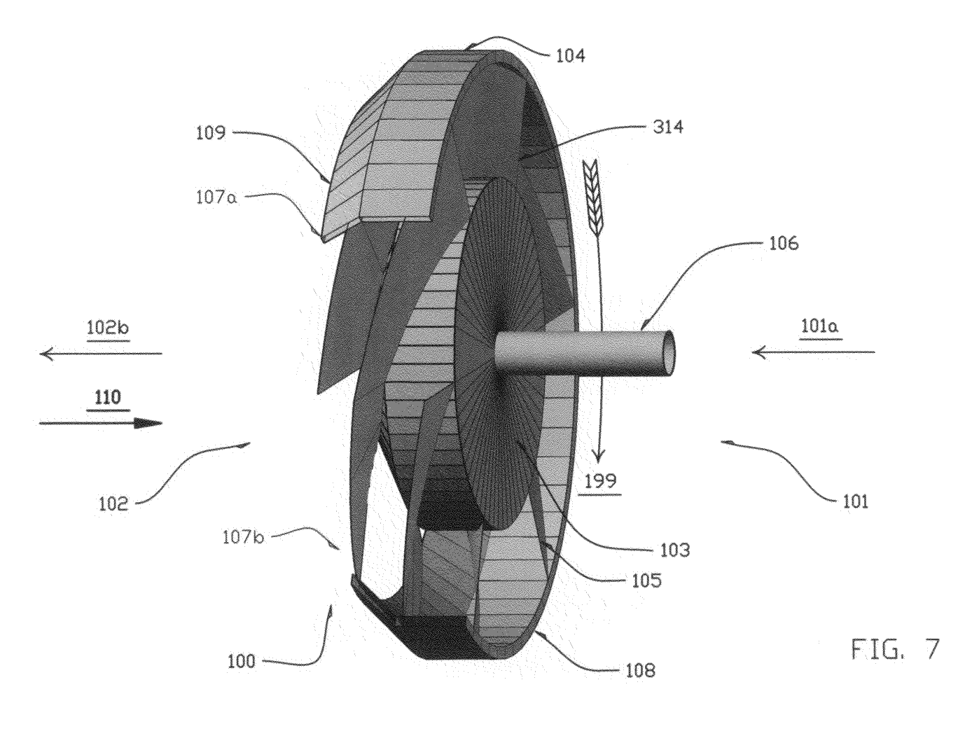

FIG. 7 depicts the power generating turbine 100 of FIG. 1 but with a section 107a-107b of the rotating outer shell cut away to expose the internal vanes typical of 105 and the hub 103.

The rotating outer shell 104 is attached to the vanes 105 and rotates, as one, with the hub 103 and the vanes typical of 105.

Hub 103 is depicted, in this example, with an axially directed shaft 106 for the purpose of transmitting rotational energy from the power generating turbine 100 to an energy consuming device such as a electric generator. Alternatively, rotational energy from the power generating turbine 100 could be transmitted via the rotating outer shell.

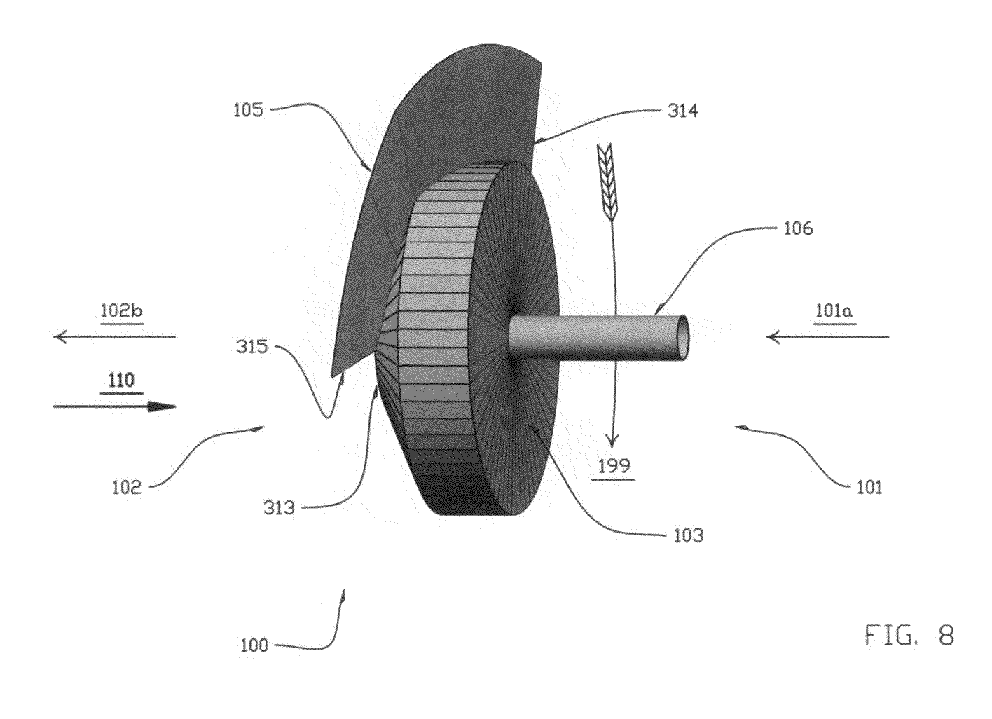

FIG. 8 depicts the entire rotating outer shell removed to expose only one of the internal vanes 105 and the hub 103. The power generating turbine 100 of this particular example turns in a clockwise direction as indicated by arrow 199 in the drawing. Thus edge 314 is a leading edge with respect to the revolving motion 199 of the vane 105 and edge 315 is a trailing edge.

The vanes typical of 105 are pitched relative to the axis of rotation 199 of the power generating turbine 100. The shaft is caused to rotate by the flow of fluid 101a into the inlet 101 and the flow of fluid 102b from the outlet 102.

As depicted in FIG. 7, the space between the outer inlet diameter 312 of the hub 103 and the inner inlet diameter 108 of the rotating outer shell 104 forms an annulus at the inlet 101 of the power generating turbine 100.

As depicted in FIG. 7, the space between the outer outlet diameter 313 of the hub 103 and the inner outlet diameter 109 of the rotating outer shell 104 forms another annulus at the outlet 102 of the power generating turbine 100.

As depicted in FIG. 8 the diameter 313 of the exit of the hub 103 is less than the diameter 312 of the entry of the hub 103. As depicted in FIGS. 6 and 7 the diameter 109 of the exit of the rotating outer shell 104 is also less than the diameter 108 of the entry of the rotating outer shell 104. Therefore the centrifugal radius of the outlet 102 annulus is less than the centrifugal radius of the inlet 101 annulus.

This reduction in centrifugal force exerted by the fluid flow 102b at the outlet 102 annulus from the centrifugal force exerted by the fluid flow 101a at the inlet 101 annulus causes rotational energy to be transmitted to the power generating turbine 100 in the direction of rotation 199. In this example the rotational energy imparted to the power generating turbine 100 is transmitted to the shaft 106 but rotational energy from the power generating turbine 100 could also be transmitted via the rotating outer shell.

The design of the rotating outer shell, the hub, and the vanes are analytically and synergistically calculated for the for the desired performance of the rotating fluid conduit.

Another computer program can then generate a three dimensional (3D) model based on the analytical solution to the desired performance. This computer generated three dimensional (3D) model can then be used to generate a tool path designed for computer aided manufacturing of the elements depicted in FIGS. 1,2,3,4,5,6,7, and 8.

The elements depicted in FIGS. 1,2,3,4,5,6,7, and 8, when configured for lower density fluids, such as air, can be constructed of materials typically used in the relevant industry (e.g., aerospace, helicopter, wind generating turbines, aircraft). These materials include but are not limited to, metals, plastics, fabrics, and/or composite materials.

The elements depicted in FIGS. 1,2,3,4,5,6,7, and 8, when configured for medium to higher density fluids, such as water, can be constructed of materials typically used in the relevant industry (e.g., marine propellers, gas turbines, steam turbines) by techniques including machine cutting, fabrication, or casting from metal or plastic or a combination of materials.

While the invention has been described in connection with the embodiments illustrated above, it is not intended to limit the scope of the invention to the particular form set forth, but on the contrary, it is intended to cover such alternatives, modifications, and equivalents as may be included within the spirit and scope of the invention. It is recognized that various equivalents, alternatives and modifications are possible within the scope of the appended claims and their legal equivalents. While several forms of the invention have been shown and described in the above teachings, other forms will now be apparent to those skilled in the art. Therefore, it will be understood that the embodiments shown in the drawings and described above are merely for illustrative purposes, and are not intended to limit the scope of the invention which is defined by the claims which follow.

The invention claimed is:

1. A rotating fluid conduit comprised of:
(a) an axis of revolution;
(b) an inlet and outlet spaced at separate points on the said axis of revolution;
(b) an inner hub rotating about said axis of revolution;
(c) an outer shell rotating about said axis of revolution;
(d) an annulus formed by the inner hub and the outer shell that varies from the inlet to the outlet; and
(d) a plurality of vanes, rotating about said axis of revolution, arranged within the annulus with said vanes affixed to the outer diameter of the inner hub at the inner diameters of the said plurality of vanes and affixed to the inner diameter of the outer shell at the outer diameters of the said plurality of vanes.

2. The rotating fluid conduit of claim 1, which controls the tangential velocity and the axial velocity of a fluid stream.

3. The rotating fluid conduit of claim 1, wherein: the performance, simulation, and three dimensional coordinates, of the structure of the rotating fluid conduit, are mathematically calculated by electronic computation.

4. The rotating fluid conduit of claim 1, wherein: a fluid flows substantially parallel to the axis of revolution when rotational energy is applied about the axis of revolution.

5. The rotating fluid conduit of claim 1, wherein: a rotational energy is transmitted about the axis of revolution when a fluid flows substantially parallel to the axis of revolution.

6. The rotating fluid conduit of claim 1, used for all types and mixtures of fluids including, but not limited to, air, gases, liquids, steam, and plasma.

7. The rotating fluid conduit of claim 1, wherein: the inlet outside diameter of the rotating hub is substantially equivalent to the outlet outside diameter of the rotating hub.

8. The rotating fluid conduit of claim 1, wherein: the inlet outside diameter of the rotating hub is nonequivalent to the outlet outside diameter of the rotating hub.

9. The rotating fluid conduit of claim 1, wherein: the inlet inside diameter of the rotating outer shell is substantially equivalent to the outlet inside diameter of the rotating outer shell.

10. The rotating fluid conduit of claim 1, wherein: the inlet inside diameter of the rotating outer shell is nonequivalent to the outlet inside diameter of the rotating outer shell.

11. The rotating fluid conduit of claim 1, wherein: the entire leading edge of the vanes are perpendicular to the axis of rotation.

12. The rotating fluid conduit of claim 1, wherein: the entire trailing edge of the vanes are perpendicular to the axis of rotation.

13. The rotating fluid conduit of claim 1, wherein: the thickness, of an individual vane, from the face of the vane to the back of the vane varies from the leading edge of the vane to the trailing edge of the vane.

14. The rotating fluid conduit of claim 1, wherein the annulus area is varied while the rotating fluid conduit is in operation.

15. The rotating fluid conduit of claim 1, wherein the angle of the vanes is varied while the rotating fluid conduit is in operation.

16. The rotating fluid conduit of claim 1, wherein the rotating outer shell extends forward of the leading edge of the vanes.

17. The rotating fluid conduit of claim 1, wherein the rotating outer shell extends behind the trailing edge of the vanes.

18. The rotating fluid conduit of claim 1, wherein the inner hub extends forward of the leading edge of the vanes.

19. The rotating fluid conduit of claim 1, wherein the inner hub extends behind the trailing edge of the vanes.

20. The rotating fluid conduit of claim 1, used as either a fully submerged marine propeller, partially submerged marine propeller, aircraft propeller, airboat propeller, power generating turbine, rotary aircraft wing, gas compressor, fan, pump impeller, or mixer.
